(19) United States
(12) Patent Application Publication
(10) Pub. No.: US 2023/0241872 A1
(43) Pub. Date: Aug. 3, 2023

(54) PACKAGING INSERT

(71) Applicant: RKW SE, Mannheim (DE)

(72) Inventors: Reinhard EPPING, Gronau (DE); Ayhan SODO, Gronau (DE); Michael SCHERER, Wasserburg (DE)

(73) Assignee: RKW SE, Mannheim (DE)

(21) Appl. No.: 17/781,441

(22) PCT Filed: Nov. 4, 2021
(86) PCT No.: PCT/EP2021/080654

§ 371 Date: Jun. 1, 2022

(30) Foreign Application Priority Data
Dec. 1, 2020 (DE) 10 2020 131 755.7

(51) Int. Cl. B32B 27/12; B32B 3/26; B32B 27/32; B32B 27/18; B32B 5/02; B65D 81/26

(52) U.S. Cl. CPC B32B 27/12; B32B 3/266; B32B 27/32; B32B 27/18; B32B 5/022; B32B 3/263; B65D 81/264; B32B 2307/718; B32B 2307/726; B32B 2307/7265; B32B 2439/70; B32B 2262/0253; B32B 2307/728

(57) ABSTRACT

A packaging insert for the absorption of a liquid with a covering layer (1) for foods. The covering layer (1) has perforations (2) that allow the liquid to pass through. The covering layer (1) is connected to a storage area (4), wherein (4) connecting areas (3) are formed between the covering layer (1) and the storage area. The storage area (4) has a nonwoven content of more than 70 wt. %. The packaging insert shows a buoyancy in water for floating. The nonwoven is composed of a plastic that has a density of less than 0.99 g/cm³ and/or the covering is composed of a plastic that has a density of less than 0.99 g/cm³.

### TECHNICAL FIELD

The invention relates to a packaging insert for the absorption of a liquid with a covering layer for foods, wherein the covering layer has perforations that allow the liquid to pass through, and the covering layer is connected to a storage area, wherein connecting areas are formed between the covering layer and the storage area, AND wherein the storage area has a nonwoven content of more than 70 wt. %.

### BACKGROUND

There is a continuing demand in the food industry for packaging inserts or absorbent inserts for the hygienic storage and presentation of foods that release liquids, for example meat, fish or vegetables. Absorption of the liquid released by the foods improves both the shelf life and the optical impression of the food.

DE 10 2015 009 334 A1 describes an absorbent insert for foods with at least two layers of material. Between the layers of material is an absorber material. The connecting areas are configured such that with increasing swelling pressure, they yield to the expansion of the absorber material. The absorbent insert is treated at its outer edges to prevent liquid leakage.

Fruits and vegetables themselves often release only small amounts of liquid, but they also release the wash water adhering after washing, which then collects in the bottom of the food packaging tray. Compared for example to packed meat, however, the total amount of liquid is less. This therefore also allows absorbent inserts with a reduced amount of absorber material or alternative liquid-binding materials.

An example of an absorbent insert for fruit according to the prior art is constructed based on pulp fibers. Pulp refers to the fibrous mass produced on chemical degradation of plant fibers, which consists primarily of cellulose. In order to prevent direct contact between the absorbent body and the food, the absorbent body is provided with a film. In frequent cases, this “sealing off” is only partial. Therefore, it is nevertheless possible for short fibers to come into contact with the food.

DE 20200661 U1 describes an absorbent laminated insert for food packagings. Between two film layers, the upper of which is perforated, is an absorbent layer of randomly placed pulp fibers in which a superabsorber is finely dispersed.

Both absorbent inserts based on superabsorbers and inserts with pulp fibers are classic disposable packages, which must be disposed of after the food is purchased. The need for recyclable absorbent inserts is being driven by climate change, which is becoming more and more evident, as well as by the increasing environmental consciousness of consumers.

### SUMMARY

The object of the present invention is to provide a packaging insert for fruit that can be easily recycled. Moreover, the packaging insert must be capable of reliably absorbing liquid released by the fruit and the wash water. The packaging insert is intended to contribute toward increasing the shelf life of the fruit and at the same time to ensure that the fruit makes a favorable optical impression. The packaging insert must also pose no health hazard and be environmentally sustainable. The packaging insert is to be produced from a recyclable material without the addition of superabsorbers. Moreover, the packaging insert must be pleasant to the touch and form a bed for the fruit without producing any pressure points. Furthermore, the liquid should be prevented from escaping.

This object is achieved according to the invention by a packaging insert for foods and use thereof having one or more of the features described herein. Preferred variants are given in the claims, the description, the exemplary embodiments and the drawings.

According to the invention, the packaging insert has permanent buoyancy in water for floating, wherein the nonwoven is composed of a plastic that has a density of less than 0.99 g/cm³ and/or the covering layer is composed of a plastic that has a density of less than 0.99 g/cm³. In this manner, the packaging insert can float during recycling in a separation process and can be recycled in a sustainable manner.

Advantageously, the packaging insert is permanently buoyant. The fibers of the nonwoven and the covering layer themselves are produced from a synthetic plastic, so that the two layers of the packaging insert do not absorb liquid until they are full, which could alter the buoyancy of the packaging insert.

Buoyancy, in particular static buoyancy, is a phenomenon in which a body that is submerged in a resting fluid appears to lose weight. The gravitational force of the body is partially, completely or excessively compensated for by the static buoyant force.

When the static buoyant force is compared with the gravitational force of the body in question, the ratio of the densities of the body and fluid is decisive for this comparison. A body floats in a fluid when its average density is exactly equal to that of the surrounding fluid. It rises if its density is lower or sinks if its density is greater.

Density, also referred to as mass density, is the mass of a body divided by its volume. Density is determined by the material of the body, and as an intensive variable, it is independent of the shape and dimensions thereof. In general, substances expand with increasing temperature, causing their density to decrease. Pure and air-free water shows a density at atmospheric pressure and 20° C. of 0.998 g/cm³.

According to the invention, the nonwoven of the storage area of the packaging insert is composed of a material that has a density of less than 1 g/cm³. In this manner, the packaging insert can float during recycling in a separation process and can be recycled in a sustainable manner.

The packaging insert according to the invention allows the trouble-free use of a float/sink method. A prerequisite for this method is that the substances to be separated must be of different density. In use of the method, a mixture of different substances whose density lies between that of the substances to be separated is placed in a liquid bath. Water is often used for this purpose. A substance then sinks to the bottom due to its higher density, while the second substance floats to the surface due to its lower density. After the method has been used, the liquid bath can be carefully decanted and filtered in order to obtain the two substances separately. The float/sink method is particularly well-suited for the recycling of plastics.

Conventional packaging inserts sink to the bottom during this recycling and stop up the feed pumps. In contrast, the packaging insert according to the invention ensures reliable floating and prevents blockages of the conveying devices of the recycling unit.

Advantageously, the nonwoven is composed of a polyolefin, preferably unmixed polypropylene. This is particularly advantageous for implementing a closed recycling loop in which the packaging insert can be separated by the float/sink method.

Ideally, the nonwoven is composed of a material that has a density of less than 0.97 g/cm³, preferably less than 0.96 g/cm³, in particular less than 0.95 g/cm³ and/or more than 0.87 g/cm³, preferably more than 0.88 g/cm³, in particular more than 0.89 g/cm³. This makes the packaging insert particularly well-suited for separation by the float/sink method.

A nonwoven is a structure of fibers of limited length, endless fibers or cut yarn of any type and any origin that are combined in any manner into a nonwoven and joined to one another in any way. Nonwoven fabrics are mostly flexible textile flat structures, i.e. they bend readily and their main structural elements are textile fibers, preferably synthetic fibers.

The terms “nonwoven fabric” or “web” refer in this invention to a substance that can be produced from continuous filaments and/or discontinuous fibers without weaving or knitting by means of methods such as spunbonding, carding or melt blowing. The nonwoven can comprise one or a plurality of layers of nonwoven fabric, wherein each layer can contain continuous filaments or discontinuous fibers.

Ideally, the nonwoven is composed of polypropylene. The production of a storage area for liquids that adhere to fruit or are released by fruit composed of a polyolefin, in particular of 100% polypropylene, is highly promising for implementing a closed recycling loop for food packaging articles. Spinnable polymers, in particular polypropylene, have been found to be suitable as a material for the production of endless filaments.

A nonwoven content of the storage area of more than 80 wt. %, preferably more than 95 wt. %, in particular more than 99 wt. % has been found to be particularly favorable. This makes it possible in a particularly advantageous manner to achieve a high absorption capacity for liquid that is released from the fruit placed on the package insert during transport for sale. The nonwoven stores the liquid solely through the capillary action exerted by the interstices of the endless filament fibers. The nonwoven stores the liquid highly reliably in a purely physical manner.

Preferably, the nonwoven layer is composed of a hydroentangled nonwoven fabric. Hydroentanglement allows fibers in a nonwoven fabric to be reoriented such that the original two-dimensional fiber alignment is converted into a three-dimensional fiber orientation. The individual fibers are more strongly incorporated into the nonwoven structure. The nonwoven remains free of bonding points, which for example are produced in thermobonding, with the result that the nonwoven has a greater capillary action for storage of the liquid.

In a particularly advantageous variant of the invention, the storage area is completely composed of a nonwoven. In particular, a hydroentangled endless filament nonwoven from the firm RKW SE (HyJet® product group) has been found to be favorable for this purpose. This prevents individual fibers from coming loose and attaching to foods, in particular at cut edges. This plays a particularly important role from the standpoint of safety and health.

It is possible only by using a special hydroentangled endless filament web (HyJet®), which is preferably composed of round fibers, to form storage areas that quickly and to a sufficient degree absorb liquid accumulating from the food and store it permanently. According to the invention, it is possible based on the capillarity of the spaces between the fibers alone to bind the liquid into the nonwoven.

In a particularly favorable embodiment of the invention, a nonwoven of hydroentangled polypropylene endless filaments is used. In order to ensure sufficient and rapid absorption of the accumulating liquid by the storage area, the nonwoven has a weight per unit area of less than 100 g/m², preferably less than 80 g/m², in particular less than 60 g/m². Advantageously, the weight per unit area of the nonwoven material is more than 20 g/m², preferably more than 30 g/m², in particular more than 40 g/m².

In use as a packaging insert in the area of foods, layers of material of nonwoven fabric in which the filaments have a thickness of more than 0.1 μm, preferably more than 1 μm, in particular more than 10 μm, have been found to be particularly favorable. Filaments for such nonwoven fabric preferably having a thickness of less than 200 μm, in particular less than 150 μm and preferably less than 70 μm have been found to be particularly suitable. In a particularly favorable embodiment of the invention, the filaments measure between 10 and 70 μm. This ensures favorable liquid binding through the capillary action and sufficient filament stability, thus preventing breakage of the fibers and accumulation of the broken fibers in the food.

Ideally, the storage area has a thickness of more than 200 μm, preferably more than 300 μm, in particular more than 400 μm and/or less than 900 μm, preferably less than 800 μm, in particular less than 700 μm. By means of the advantageous configuration of the thickness of the storage area and the use of the special hydroentangled endless filament nonwoven, an absorption capacity of more than 300%, preferably more than 400%, in particular more than 500% relative to the weight per unit area of the storage area is achieved. Because of the outstanding absorption and storage capacity of the storage area, one can dispense altogether with the use of superabsorbers, which makes the packaging insert easier to recycle.

Advantageously, one square meter of a packaging insert with a weight per unit area of 50 g/m² can absorb more than 250 g of liquid released by fruit or accumulating as wash water and permanently bind it because of the capillary action of the nonwoven.

According to the invention, the storage area has a hydrophilic component that improves the absorption of liquids and makes liquid binding possible. Preferably, the hydrophilic component is an ester, preferably an alcohol polyglycol ester, in particular a fatty alcohol polyglycol ester. As the hydrophilic component of the storage area enables binding of the wash water of the fruit by the packaging insert, the fruit in the food packaging remains dry and fresh for long periods.

Preferably, the hydrophilic component has a storage area ratio of more than 0.2 wt. %, preferably more than 0.3 wt. %, in particular more than 0.4 wt. % and/or preferably less than 0.8 wt. %, preferably less than 0.7 wt. %, in particular less than 0.6 wt. %.

According to the invention, the covering serves as the contact surface between the packaging insert and the fruit. The fruit is bedded on the covering layer of the packaging insert and thus lies on the packaging insert.

Ideally, the covering layer is directly connected to the storage area. Both are firmly arranged adjacent to and atop each other. Preferably, the connecting areas are a plurality of bonding points arranged in a grid-like manner, which in particular are configured as bodies having a truncated cone shape.

Particularly advantageous is the configuration of the covering layer from a material that has a density of less than 0.98 g/cm³, preferably less than 0.96 g/cm³, in particular less than 0.94 g/cm³ and/or more than 0.85 g/cm³, preferably more than 0.87 g/cm³, in particular more than 0.89 g/cm³.

According to the invention, the covering layer is composed of a polyolefin, preferably a polypropylene. Ideally, the covering layer is composed of up to 100% pure polypropylene.

In a particularly advantageous variant of the invention, both the nonwoven and the covering layer are therefore composed of polypropylene. Accordingly, the packaging insert is ideally a pure polypropylene product, which considerably facilitates recycling of the packaging insert.

In the use of a float/sink recycling method, a packaging insert produced almost exclusively from low-density polypropylene is particularly favorable as this ensures reliable floating, thus preventing blockages in the recycling process, and at the same time, one obtains a pure unmixed material in the form of a pure polyolefinic plastic.

In particular, because of its recycling capacity, polypropylene is favorable for food packagings in order to implement a closed recycling loop.

According to the invention, connecting areas are formed between the covering layer and the storage area. In this manner, the covering layer is directly connected to the storage area, which gives rise to a fixed assignment and arrangement of the covering layer with respect to the storage area. The connecting areas are preferably a plurality of bonding points in a lattice-like arrangement. These are produced by means of ultrasonic technology and thus bond the covering layer to the storage area.

Ideally, the connection between the covering layer and the storage area is limited to a minimum of bonding points. This allows the capillary action of the nonwoven fabric for storing the liquid to be retained to the greatest extent possible.

The ultrasonic joining technology melts the layers of material at the bonding points by means of the energy introduced, which results in permanent chemical bonding of the layers with identical polymers. In the case of non-identical polymers, the melt flows from the covering layer into the fiber matrix and forms a mechanical bond there.

Relative to the total area of the packaging insert, the connecting areas have a surface area ratio of more than 0.5%, preferably more than 1.0%, in particular more than 1.5% and/or less than 15%, preferably less than 10%, in particular less than 5%. The connecting areas provide permanent bonding of the covering layer to the storage.

It has been found to be particularly favorable if the covering layer has perforations to allow a liquid to pass through. In particular, fruit is washed before being packaged for sale. This often causes wash water to adhere to the fruit when it is packaged. This wash water is then slowly released and collects on the covering layer. Advantageously, the perforations of the covering layer quickly conduct the collected wash water and any fruit juice released into the storage area, where the nonwoven stores the wash water and the fruit juice by means of capillary action.

The perforations of the covering layer are produced, for example, in that a thermoplastic polymer film in a molten state is fed into a vacuum perforation device. The polymer film is partially suctioned by a vacuum device into holes in a roller, wherein the polymer melt forms elongated cavities in the form of protuberances that are open at the bottom. After cooling of the film, the vacuum-perforated covering layer is removed and fed into the bonding device with the storage area.

In another variant of the perforation method, a thermoplastic film is heated and fed over an element that has holes. A vacuum is applied in this case as well. The heated film is pulled into the area of the holes such that ripped protuberances are formed that have a wall, form an elongated cavity, and enclose the perforation opening.

The protuberances can have a tapered configuration, such that the narrowest cross section is formed by the outer edge of the protuberance. Cylindrical protuberances can also be formed in which the cross section of the cavity largely remains constant. In a particularly advantageous embodiment of the invention, the protuberances have narrowed areas. Beginning from a narrowest cross section, the free cross section of the cavity expands toward the upper and lower opening.

In an advantageous variant of the invention, the plane of the covering layer is arranged at a distance from the storage area. The protuberances protrude from the plane of the covering layer toward the storage area. The perforations lie in the plane of the covering layer, while the edges of the protuberances protrude toward the storage area.

It has been found to be particularly favorable when the covering layer produced according to this variant by vacuum perforation has a weight per unit area of more than 20 g/m², preferably more than 30 g/m², in particular of more than 40 g/m² and/or less than 80 g/m², preferably less than 70 g/m², in particular less than 60 g/m².

The covering layer produced according to this variant by vacuum perforation ideally has a thickness of more than 100 μm, preferably more than 200 μm, in particular of more than 400 μm and/or less than 800 μm, preferably less than 700 μm, in particular less than 600 μm.

In an alternative variant of the invention, the perforations are produced by means of the needle perforation method. This gives rise to curved and short open protuberances of the covering layer that feed the liquid of the fruit into the storage area.

It has been found to be particularly favorable when the covering produced according to this alternative variant by needle perforation has a weight per unit area of more than 5 g/m², preferably more than 10 g/m², in particular more than 12 g/m² and/or less than 25 g/m², preferably less than 20 g/m², in particular less than 18 g/m².

Relative to the total area of the covering layer, the perforations have an area ratio of more than 5%, preferably more than 7.5%, in particular more than 10% and/or less than 60%, preferably less than 55%, in particular less than 50%. The advantageous configuration of the perforation ratio allows the released wash water of the fruit to be quickly fed through the perforations into the storage area. This allows the fruit above the covering layer to remain dry, both making it optically appealing for a longer period and also extending its shelf life.

Ideally, the covering layer has a hydrophilic component. This imparts to the covering layer a pulling action on the wash water of the fruit, which favors and promotes the feeding thereof into the storage area of the packaging insert.

Preferably, the hydrophilic component is an alditol and/or a sorbitol, preferably a [(2R)-2-[(2R,3R,4S)-3,4-dihydroxyoxolan-2-yl]-2 -hydroxyethyl]-dodecanoate. Ideally, the hydrophilic component has a content of more than 0.2 wt. %, preferably more than 0.3 wt. %, in particular more than 0.4 wt. % and/or less than 0.8 wt. %, preferably less than 0.7 wt. %, in particular less than 0.6 wt. %.

According to the invention, a material layer that is impermeable to liquid is arranged on the underside of the storage area. The material layer is produced from a polyolefin, preferably a polypropylene. This is highly advantageous, particularly when the covering layer and the storage area are also produced from polypropylene in order to implement a closed recycling loop for polypropylene-based packaging articles.

It has been found to be particularly favorable when the material layer has a thickness of more than 2 μm, preferably more than 4 μm, in particular more than 6 μm and/or less than 30 μm, preferably less than 25 μm, in particular less than 20 μm.

In a preferred variant of the invention, the material layer has a weight per unit area of less than 40 g/m², preferably less than 30 g/m², in particular less than 20 g/m² and/or more than 2 g/m², preferably more than 4 g/m², in particular more than 6 g/m².

The use according to the invention of a packaging insert as a pad having an absorption and storage capacity for liquid-releasing fruit is particularly advantageous. In particular, the production of a packaging insert of 100% polypropylene is highly promising for implementing a closed recycling loop for packaging articles. At the same time, the packaging insert is impressive due to its excellent absorption capacity and its enormous capacity for permanently storing liquid from fruit and wash water that adheres to the fruit. The packaging insert according to the invention is particularly suitable for recycling as it uses no superabsorbers or comparable materials whatsoever.

In a highly advantageous variant of the invention, the packaging insert is configured such that it can be recycled from a volume of packaging waste by means of floating in a water container in the so-called float/sink method. Because of the low density of the packaging insert, it floats to the surface and can be skimmed off. In this manner, the packaging insert of unmixed polypropylene can be selectively recycled.

### BRIEF DESCRIPTION OF THE DRAWINGS

Further advantages and features of the invention are given in the description of an exemplary embodiment with reference to two drawings and in the drawings themselves. The figures are as follows:

FIG. 1 shows a cutaway section of a packaging insert according to the invention, and

FIG. 2 shows a section through the covering layer.

### DETAILED DESCRIPTION

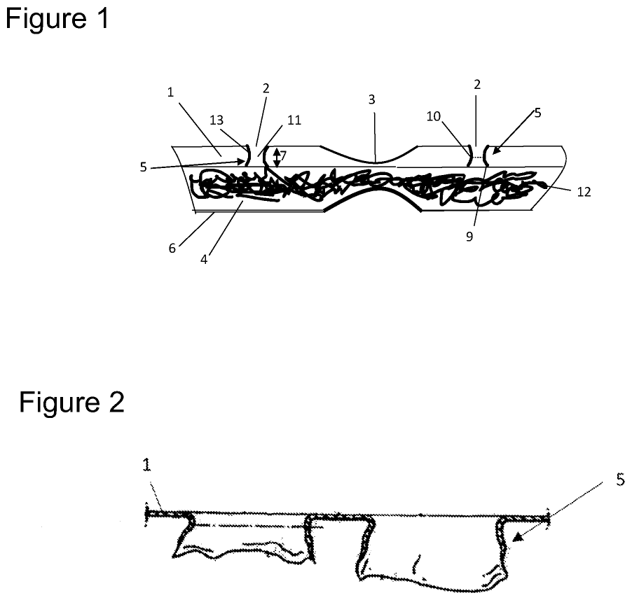

FIG. 1 shows a section of a schematic diagram of a packaging insert. The packaging insert is composed of a covering layer 1 and a storage area 4 connected thereto. The covering layer 1 has a plurality of perforations 2 in order to allow a liquid to pass through into the storage area 4. The storage area 4 is composed in this exemplary example of a nonwoven of endless filaments 12 that is hydroentangled and composed completely of polypropylene. A liquid-impermeable material layer 6 that prevents liquid leakage into the packaging tray, which is not shown, is connected to the underside of the storage area 4.

The covering layer 1, the storage area 4 and the material layer 6 are permanently joined by connecting areas 3 produced by means of ultrasonic joining technology and are oriented in both their arrangement and assignment.

The covering layer 1 has perforations 2 produced by vacuum perforation. Open protuberances 5 that extend in the direction of the storage area 4 to a height 7 are connected from below to the perforations 2. In this exemplary example, the height 7, which corresponds to the thickness of the covering layer 1, is approx. 300 μm. Each protuberance 5 has a wall 13 that forms a cavity 11 and encloses the perforation 2. The perforations 2 are enclosed by the wall 13 of the protuberances 5. The cavities 11 extend from the perforation 2 to the storage area 4 and can very quickly conduct the liquid from the fruit to the nonwoven of endless filaments 12.

In the exemplary embodiment, the cavities 11 have a narrowest cross section 10. Beginning from this narrowest cross section 10, the cross section of the cavities 11 expands toward the storage area 4, where the free edge 9 of the protuberances 5 is connected to the storage area. The cross section of the cavity 11 increases in an axial direction from the site of the narrowest cross section 10 to the free edge 9 of the protuberances 5.

The storage area 4 has a thickness of approx. 600 μm and the material layer 6 has a thickness of approx. 15 μm. The weight per unit area of the covering layer 1 is 50 g/m², the weight per unit area of the storage area 4 is 50 g/m², and the weight per unit area of the material layer 6 is 15 g/m². In this exemplary embodiment of the invention, the absorption capacity of the storage area 6 is 500% of the weight per unit area. The packaging insert is completely produced based on polypropylene and is free of superabsorbers.

FIG. 2 shows the covering layer 1 according to the invention with the protuberances 5, which were produced by means of a vacuum perforation device.

In the following, the invention is further explained by means of examples:

### Example 1

The packaging insert is composed of a covering layer with a weight per unit area of 50 g/m² and a storage area with a weight per unit area of 50 g/m². The covering layer is vacuum-perforated and has an area ratio of the perforations of 40%. The thickness of the covering layer is 300 μm and the thickness of the storage area is 600 μm. The storage area is composed of a nonwoven of 100% RKW-HyJet® and has an absorption capacity of 500% of its weight per unit area. This nonwoven is a hydroentangled nonwoven of round endless filaments based on polypropylene, wherein the polymer is for example a homopolymer of Borealis PP HG475FB with a melt index of 25-35 g/10 min (230° C./12.16 kg). The covering layer and the storage area are 100% produced from polypropylene and joined by means of ultrasonic joining technology. The connecting areas have an area ratio of the packaging insert of 2%. Both the covering layer and the storage area are equipped with a hydrophilic component.

### Example 2

The packaging insert is composed of a covering layer with a weight per unit area of 50 g/m², a storage area with a weight per unit area of 50 g/m² and a material layer with a weight per unit area of 15 g/m². The covering layer is vacuum-perforated and has an area ratio of the perforations of 45%. The thickness of the covering layer is 300 μm, the thickness of the storage area is 600 μm and the thickness of the material layer is 15 μm. The storage area is composed of a nonwoven of 100% RKW-HyJet® and has an absorption capacity of 500% of its weight per unit area. The covering layer, the storage area and the material layer are joined by means of ultrasonic joining technology. In this example, a polyethylene-based vacuum-perforated film is used as a covering layer. The covering layer is equipped with the hydrophilic component [(2R)-2-[(2R,3R,4S)-3,4- dihydroxyoxolan-2-yl]-2-hydroxyethyl]-dodecanoate and the storage area with a fatty alcohol polyglycol ester. The connecting areas have an area ratio of the packaging insert of 2%. The material layer is liquid-impermeable.

### Example 3

The packaging insert is composed of a covering layer with a weight per unit area of 15 g/m², a storage area with a weight per unit area of 50 g/m² and a material layer with a weight per unit area of 15 g/m². All three layers are needle-perforated. The perforations have an area ratio of 25%. In this example, in which a needled 15 g/m² film based on polypropylene is used, the thickness of the covering layer is 15 μm, the thickness of the storage area is 600 μm and the thickness of the material layer is 15 μm. The storage area is composed of a nonwoven of 100% RKW-HyJet® and has an absorption capacity of 500% of its weight per unit area. The covering layer, the storage area and the material layer are 100% produced from polypropylene. All three layers are joined by means of ultrasonic joining technology. The material layer is liquid-impermeable.

### Example 4

The packaging insert is composed of a covering layer with a weight per unit area of 15 g/m², a storage area with a weight per unit area of 50 g/m² and a material layer with a weight per unit area of 15 g/m². The covering layer is needle-perforated. The perforations have an area ratio of 35%. The thickness of the covering layer is 15 μm, the thickness of the storage area is 600 μm and the thickness of the material layer is 15 μm. The storage area is composed of a nonwoven of 100% RKW-HyJet® and has an absorption capacity of 500% of its weight per unit area. The covering layer, the storage area and the material layer are 100% produced from polypropylene. All three layers are joined by means of ultrasonic joining technology. The connecting areas have an area ratio of the packaging insert of 2.0%. The material layer is liquid-impermeable.

1. A packaging insert for absorption of a liquid, the packaging insert comprising:
a covering layer for foods, the covering layer has perforations configured to allow the liquid to pass through;
a storage area connected to the covering layer; and
connecting areas formed between the covering layer and the storage area;
wherein the storage area has a nonwoven content of more than 70 wt. %, the packaging insert has a buoyancy in water for floating, and at least one of the nonwoven is composed of a plastic that has a density of less than 0.99 g/cm³ or the covering layer is composed of a plastic that has a density of less than 0.99 g/cm³.

2. The packaging insert as claimed in claim 1, wherein the nonwoven is composed of a plastic that has a density of less than 0.97 g/cm³ and more than 0.87 g/cm³.

3. The packaging insert as claimed in claim 1, wherein that the nonwoven is composed of a polyolefin.

4. The packaging insert as claimed in claim 1, wherein the covering layer is composed of a plastic that has a density of less than 0.98 g/cm³and more than 0.85 g/cm³.

5. The packaging insert as claimed in claim 1, wherein the covering layer is composed of a polyolefin, preferably a polypropylene.

6. The packaging insert of claim 1, wherein the nonwoven content of the storage area is more than 80 wt. %.

7. The packaging insert of claim 1, wherein the nonwoven is composed of endless filaments.

8. The packaging insert as claimed in claim 1, wherein the nonwoven is hydroentangled.

9. The packaging insert as claimed in claim 1, wherein the nonwoven has a weight per unit area of more than 20 g/m² and less than 100 g/m².

10. The packaging insert as claimed in claim 1, wherein the storage area has an absorption capacity of more than 300% relative to a weight thereof per unit area.

11. The packaging insert as claimed in claim 1, wherein the storage area comprises a hydrophilic component, a ratio of the hydrophilic component in the storage area is more than 0.2 wt. % and less than 0.8 wt. %.

12. The packaging insert as claimed in claim 1, wherein the connecting areas have a surface area ratio of more than 0.5% and less than 15%.

13. The packaging insert as claimed in claim 1, wherein the perforations of the covering layer are configured as openings formed as open protuberances that are oriented in a direction of the storage area, and the protuberances are formed as vacuum perforation.

14. The packaging insert as claimed in claim 1, wherein the perforations of the covering layer are configured as needle perforations.

15. The packaging insert as claimed in claim 1, wherein the covering layer has a hydrophilic component, and the hydrophilic component has a content of more than 0.2 wt. % and less than 0.8 wt. %.

16. The packaging insert as claimed in claim 1, further comprising a liquid-impermeable material layer arranged on an underside of the storage area that is composed of a polyolefin.

17. A method of preserving food, comprising inserting the packaging insert as claimed in claim 1 in packaging for food for absorption of a liquid from the food.
